(19) United States
(12) Patent Application Publication
(10) Pub. No.: US 2010/0124054 A1
(43) Pub. Date: May 20, 2010

(54) Light-emitting diode lamp

(76) Inventors: HSUEH-CHEN CHEN, Taichung County (TW); Kuo-Kuang Chan, Taichung County (TW); Pen-Hao Huang, Taichung County (TW)

Correspondence Address: Dr. BANGER SHIA;Patent Office of Bang Shia, 102 Lindencrest Ct., Sugar Land, TX, 77479-5201, US

(21) Appl. No.: 12/271,919

(22) Filed: Nov. 16, 2008

(51) Int. Cl. F21S 4/00

(52) U.S. Cl. 362/221; 362/249.02; 362/225

(57) ABSTRACT

A light-emitting diode lamp which can be directly inserted into a lamp holder supplying AC power can utilize a power supply unit in a connector to supply the rectified and transformed power to an emission board to enable the light-emitting diodes on the emission board to emit light. Since the power consumption can be greatly reduced by using the light-emitting diodes, and the power supply unit or the emission board is replaceable, respectively, the requirements of environment protection and energy-saving can be satisfied.

### BACKGROUND OF THE INVENTION

1. Field of the Invention

The present invention relates to a LED lamp, and more particularly to a LED lamp whose emission board and power supply unit can be replaced respectively.

2. Description of the Prior Art

Light is an indispensible necessity for today's life, without it, many activities cannot be successfully carried out. Although conventional common tungsten-filament lamps are convenient and inexpensive in use, most of the power consumed by the tungsten-filament lamps is used to generate heat but not emit light, thus causing waste of electric energy. With the development of technology, energy-saving light-emitting diodes have been applied in the illumination field. The light-emitting diode not only has the advantages of small volume and rapid respond speed but also has the advantage of saving energy.

Referring to FIG. 1, a conventional LED lamp as disclosed in Taiwan Patent No. M326122 comprises an emission board 10 accommodated in a light-transmittable tube 20. Both ends of the light-transmittable tube 20 are connected to a pair of connectors 30 which can be inserted into a lamp holder. The emission board 10 includes a base board 11 which is provided with plural light-emitting diodes 12 and a power supply unit 13. After rectifying and transforming the received AC power, the power supply unit 13 will supply the rectified and transformed power to the lamp holder to enable the light-emitting diodes 12 to emit light. The plural light-emitting diodes 12 and the power supply unit 13 are inlaid in the base board 11. The connectors 30 of such a conventional LED lamp is not disconnectable, so that when the light-emitting diodes 12 or the power supply unit 13 on the base board 11 is damaged, the whole lamp must be replaced with a new one, thus not satisfying the requirements of environmental protection and energy-saving.

The present invention has arisen to mitigate and/or obviate the afore-described disadvantages.

### SUMMARY OF THE INVENTION

The primary objective of the present invention is to provide a LED lamp which has replaceable components to make the best use of everything, thus achieving advantage of energy-saving.

In order to achieve the above objective, a LED lamp in accordance with the present invention comprises an emission board, a tube body, a power supply unit and two connectors. The emission board includes a base board provided with plural light-emitting diodes and accommodated in the tube body. The two connectors are a first connector and a second connector which are connected to two ends of the tube body, respectively. The power supply unit is accommodated in the second connector and connected to the emission board and the second connector. The respective connectors include two inserting electrodes to be inserted into a lamp holder. After transforming and rectifying the inputted AC power, the power supply unit will supply the transformed and rectified power to the light-emitting diodes on the emission board to enable light-emitting diodes to emit light. When the emission board or the power supply unit is damaged, the damaged emission board, power supply unit or the respective components can be replaced with a new one, thus making the best use of ever thing and achieving the advantage of energy-saving.

### BRIEF DESCRIPTION OF THE DRAWINGS

FIG. 1 is a perspective view of a conventional LED lamp;

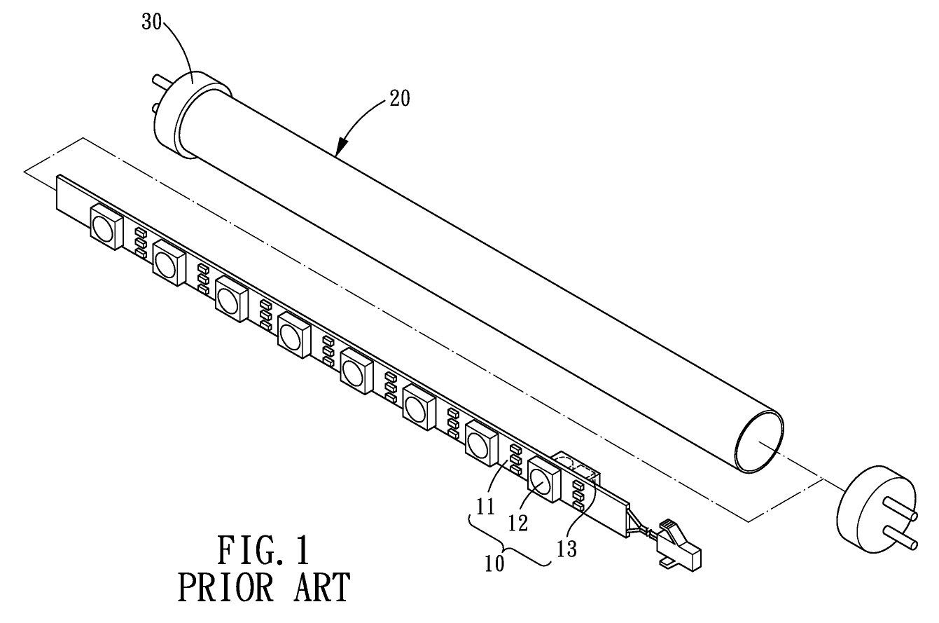

FIG. 2 is an exploded view of a LED lamp in accordance with a first embodiment of the present invention;

FIG. 3 is an assembly view of the LED lamp in accordance with the first embodiment of the present invention;

FIG. 4 illustrates the use state of the LED lamp in accordance with the first embodiment of the present invention;

FIG. 5 is an exploded view of a LED lamp in accordance with a second embodiment of the present invention; and

FIG. 6 is an assembly view of the LED lamp in accordance with the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

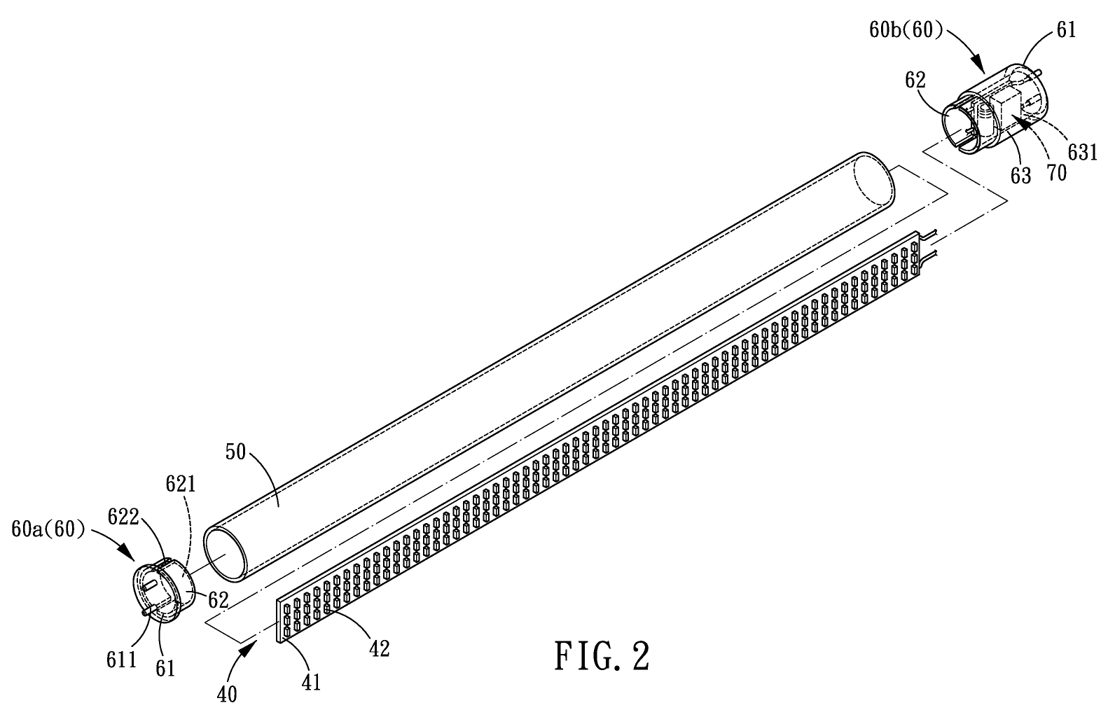

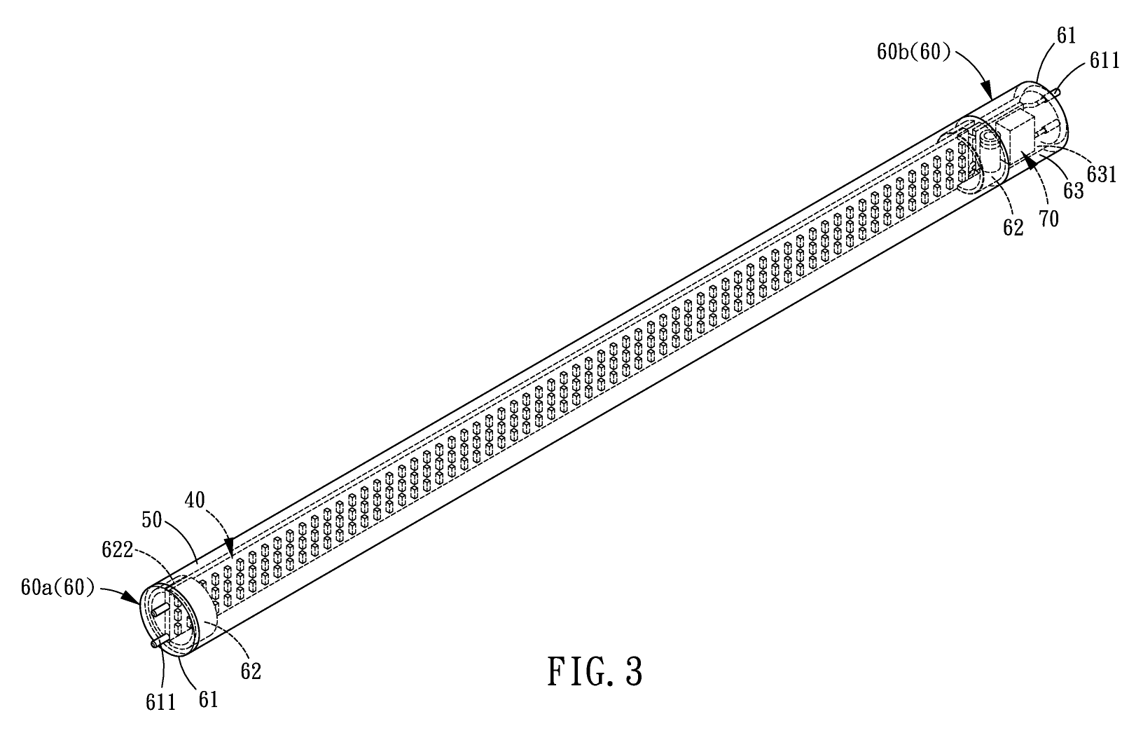

Referring to FIGS. 2-3, a light-emitting diode (LED) lamp in accordance with a first embodiment of the present invention comprises an emission board 40, a tube body 50, two connectors 60 and a power supply unit 70.

The emission board 40 includes a base board 41 provided with plural light-emitting diodes 42.

The tube body 50 is light-transmittable and provided for accommodation of the emission board 40.

The two connectors 60 are a first connector 60a and a second connector 60b. The two connectors 60 are connected to two ends of the tube body 50, respectively. Each of the connectors 60 includes an inserting end 61 and an assembling end 62. Each of the inserting ends 61 includes two inserting electrodes 611. Each of the assembling ends 62 includes an assembling space 621 and two axial grooves 622. The tube body 50 is mounted on the assembling end 62 of the respective connectors 60, and the emission board 40 is engaged in the axial grooves 622 of the assembling end 62 of the respective connectors 60. The second connector 60b is further provided with a containing portion 63 between the inserting end 61 and the assembling end 62 thereof. The containing portion 63 includes a containing space 631.

The power supply unit 70 is accommodated in the containing space 631 of the containing portion 63 of the second connector 60b. The power supply unit 70 is electrically connected to the second connector 60b and the emission board 40, respectively. After transforming and rectifying the inputted AC power, the power supply unit 70 will supply the transformed and rectified power to the light-emitting diodes 42 on the emission board 40.

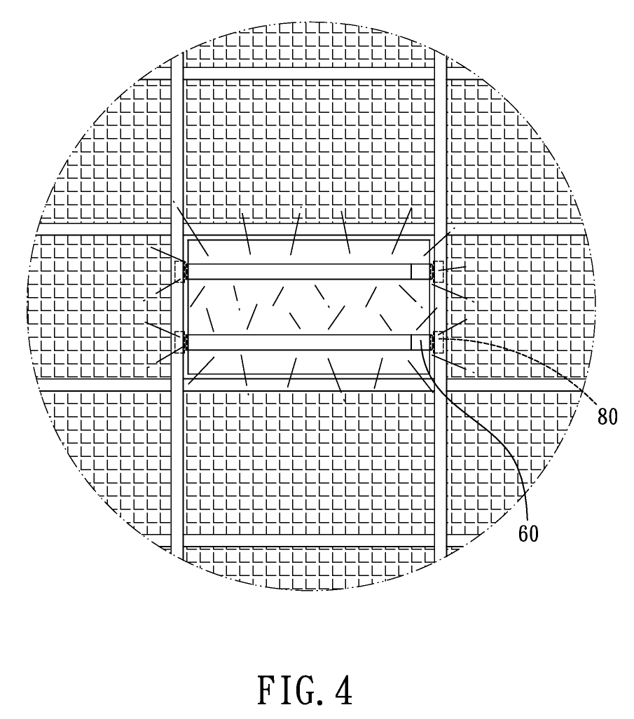

As shown in FIG. 4, the LED lamp of the present invention is assembled to a lamp holder 80 through the inserting electrodes 611 of the respective connectors 60, and the lamp holder 50 can supply the AC power to the LED lamp. When the AC power passes through the second connector 60b of the LED lamp, the power supply unit 70 in the second connector 60b will transform and rectify the inputted AC power and then supply the transformed and rectified power through the emission board 40 to enable the light-emitting diodes 42 to emit light. Since the light-emitting diodes 42 have the advantages such as low power consumption, long service life, without idling time and rapid respond speed, the LED lamps can greatly reduce the required power consumption, thus satisfying the environment protection requirements. The power supply unit 70 and the emission board 40 are separately provided on the lamp, so that when the power supply unit 70 or the emission board 40 or even the respective components are damaged, the damaged power supply unit 70 or the emission board 40 and the respective components can be replaced, thus avoiding of replacing the whole lamp. Furthermore, the power supply unit 70 can also be directly fixed in one of the connectors 60, so that if the power supply unit 70 is to be replaced, it can be replaced conveniently by replacing the connector 60.

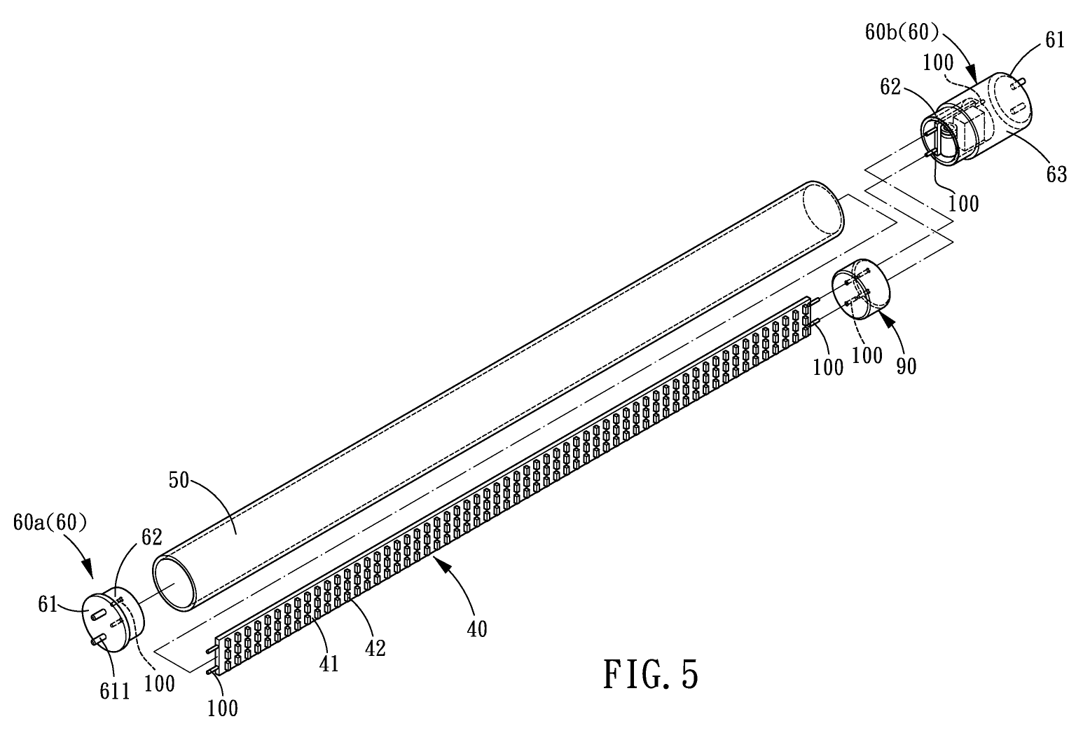

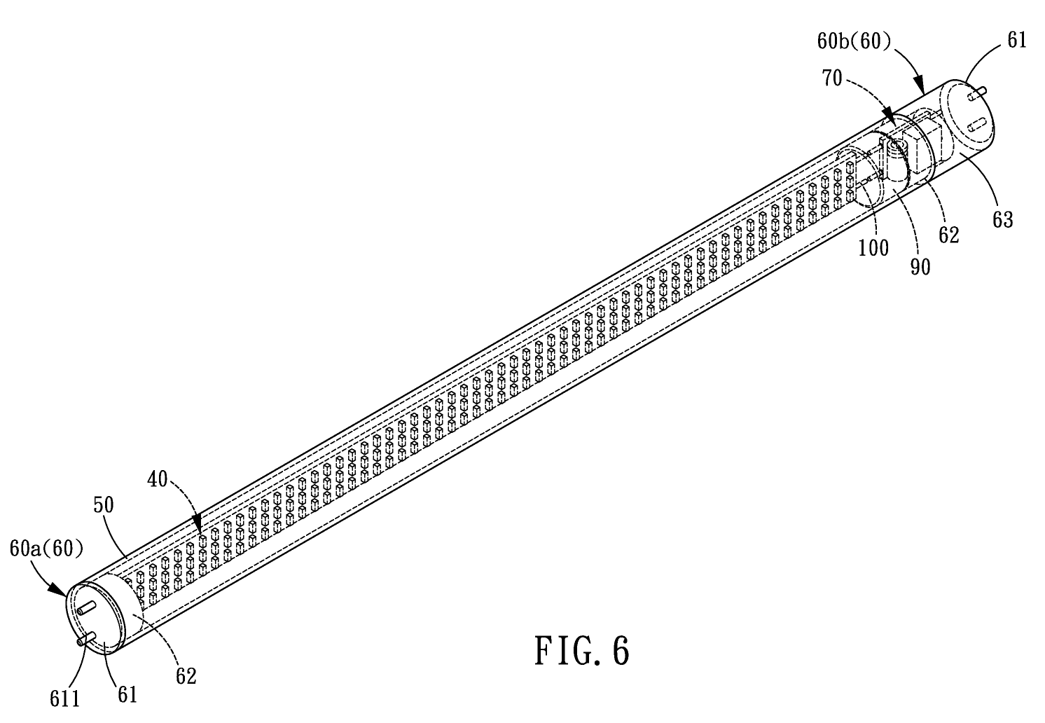

In addition, referring to FIGS. 5-6, a LED lamp in accordance with a second embodiment of the present invention is further provided with an adaptor 90 between the power supply unit 70 and the emission board 40. The adaptor 90 is provided with a connecting portion at each of two opposite sides thereof. The connectors 60, the emission board 40 and the power supply unit 70 each include a connecting portion 100. The connecting portions 100 include oppositely arranged male and female connecting portions which are engaged to each other. The respective components of the lamp in accordance with the present invention can utilize the respective connecting portions 100 to achieve the function of quick replacement. The arrangement of the adaptor 90 makes the replacement of the power supply unit 70 or the emission board 40 more convenient.

While we have shown and described various embodiments in accordance with the present invention, it is clear to those skilled in the art that further embodiments may be made without departing from the scope of the present invention.

What is claimed is:

1. A light-emitting diode (LED) lamp used together with a lamp holder, comprising:
an emission board including a base board provided with plural light-emitting diodes;
a tube body provided for accommodation of the emission board;
two connectors being a first connector and a second connector, which are connected to two ends of the tube body, respectively, the respective connectors including two inserting electrodes to be inserted into the lamp holder; and
a power supply unit accommodated in the second connector and electrically connected to the second connector and the emission board, respectively, after transforming and rectifying an inputted AC power, the power supply unit will supply the transformed and rectified AC power to the light-emitting diodes on the emission boards.

2. The light-emitting diode lamp as claimed in claim 1, wherein the respective connectors include two axial grooves at one side thereof adjacent to the tube body, the emission board is positioned in the two grooves of the respective connectors.

3. The light-emitting diode lamp as claimed in claim 2, wherein the respective connectors include an inserting end and an assembling end, the inserting electrodes are located on the inserting ends, and the axial grooves are located in the assembling ends.

4. The light-emitting diode lamp as claimed in claim 3, wherein the second connector includes a containing portion located between the inserting end and the assembling end, and the containing portion includes a containing space for accommodation of the power supply unit.

5. The light-emitting diode lamp as claimed in claim 1, wherein an adaptor is provided between the emission board and the power supply unit, the adaptor includes a connecting portion at each of two opposite sides thereof, and the emission board and the power supply unit are connected to the connecting portions of the adaptor, respectively.

6. The light-emitting diode lamp as claimed in claim 1 further comprising two connecting portions, which are provided between the first connector and the emission board and between the power supply unit and the second connector, respectively.

7. The light-emitting diode lamp as claimed in claim 5, wherein the connecting portions are engaged to each other.

8. The light-emitting diode lamp as claimed in claim 6, wherein the connecting portions are engaged to each other.
